(19) United States
(12) Patent Application Publication
(10) Pub. No.: US 2004/0007827 A1
(43) Pub. Date: Jan. 15, 2004

(54) Adhesive tape and process for producing and for attaching a sealing element to an application site

(75) Inventor: Roland Hahn, Germering (DE)

Correspondence Address: NIXON PEABODY, LLP, 401 9TH STREET, NW, SUITE 900, WASINGTON, DC, 20004-2128, US

(73) Assignee: Webasto Vehicle Systems International GmbH, Stockdorf (DE)

(21) Appl. No.: 10/601,702

(22) Filed: Jun. 24, 2003

(30) Foreign Application Priority Data
Jun. 26, 2002 (DE) 102 286 614.0

(51) Int. Cl. F16J 15/32; B28B 3/20

(52) U.S. Cl. 277/570; 277/549; 156/244.13; 156/244.26; 264/171.12; 264/176.1

(57) ABSTRACT

An adhesive tape (24), a sealing element and a process for producing the sealing element, preferably in motor vehicles. The sealing body is made of silicone, and a first self-sticking adhesive surface (18), which has at least in part a silicone cement, of an adhesive tape (24) is applied to the sealing body. The adhesive tape (24) is provided with a second self-sticking adhesive surface (20) for attachment to the application site. There is an adhesive layer (32) between the carrier element (14) of the adhesive tape (24) and the silicone cement of the first adhesive surface (18).

### BACKGROUND OF THE INVENTION

1. Field of the Invention

This invention relates to an adhesive tape and a process for producing and for attaching a sealing element which comprises a sealing body, made of silicone, applied to an application site using a silicone cement.

2. Description of Related Art

In the motor vehicle domain, there are silicone seals which are provided with an insert foot, by means of which they can be inserted at the application site. This type of attachment however entails high demand for production and installation space and is in this respect disadvantageous.

Published German Patent Application DE 199 52 399 and its counterpart U.S. Pat. No. 6,485,030 (which are commonly owned with the present application) discloses a silicone seal which can be attached by means of a liquid silicone cement to an adhesive tape which acts has a self-sticking, outer adhesive surface which is covered initially by a protective film and which is used for attachment of the seal to an application site after removing the protective film. The several hours of setting time of the liquid silicone cement complicates controlled use in mass production designed for rapid throughput. Another disadvantage of this silicone seal is that, by using liquid silicone cement, a soft-elastic connection between the carrier element and the seal body of the seal element takes place, since the liquid silicone cement, as a tacky adhesive, leads to a reversible adhesive connection which under certain loading conditions adversely affects the sealing action, for example, when used in sliding vehicle roofs. The soft-elastic connection can cause displacement up to detachment of the sealing body so that proper operation of the motor vehicle sliding roof is not ensured.

German Utility Model DE 94 17 149 U1 shows a seal with a sealing element of elastic material which has an adhesive surface by means of which it is attached to the bottom of the cover of a sliding roof, lifting roof, etc. The adhesive surface is made on an adhesive tape which is attached with its bottom to a base body which is connected to the sealing body and which is made of a material which is stiffer than the sealing body. Before attaching the seal, the adhesive surface is protected with a removable protective film.

Other sealing elements are known from German Patent PDE 197 20 713 C1 and published European Patent Application EP 0 357 973 B1, the preferred material for the sealing body being ethylene-propylene rubber (EPDM). However, this material is not optimally suited with respect to its temperature resistance, return behavior, sealing properties and the danger of freezing-on or sticking together.

### SUMMARY OF THE INVENTION

The primary object of this invention is to devise an adhesive tape and a process for producing and for attaching a sealing element with a sealing body consisting of silicone to an application site by means of which cost-favorable and economical production of a fast and simplified as well as controlled adhesive connection at the application site is enabled.

This object is achieved in accordance with the invention with respect to the adhesive tape with a carrier element which is located between two self-sticking adhesive surfaces, the sealing element being made of a silicone material and the adhesive surface facing the sealing element being formed at least partially by a silicone cement, and between the adhesive surface and the carrier element, there being an adhesive layer. With respect to the process for attachment by the steps of extruding a sealing body, applying a silicone cement (which forms the adhesive surface) to an adhesive layer of the carrier element of an adhesive tape, connecting the sealing body to the adhesive surface of the double-sided adhesive tape, and cross-linking the silicone cement by the action of temperature and/or pressure. Alternatively with respect to the process, by the steps of extruding a sealing body, producing a carrier element from acrylate foam with a protective film on the bottom, applying an adhesive layer to the top of the carrier element, applying of silicone cement (which forms the adhesive surface) to an adhesive layer, connecting the sealing body to the adhesive surface, and cross-linking the silicone cement by the action of temperature and/or pressure and/or the action of moisture. The seal is particularly useful for attachment to an openable motor vehicle roof.

An adhesive layer between the adhesive surface of a silicone cement and the carrier element made, preferably, of acrylate foam enables a simple, quick and reliable possibility of attachment of an adhesive tape to the opposing silicone surface.

Another advantage is that the silicone cement placed between the carrier element and the sealing body, supported by the adhesive layer, enables a bonded and non-positive connection which is formed by the cross-linking or complete vulcanization of the silicone cement.

Preferably, component areas of the first adhesive surface can be provided with a more quickly setting cement, for example, an acrylate cement, which, when the first adhesive surface is applied to an opposing silicone surface, provides first for tentative fixing, while the silicone cement cross-links or completely vulcanizes in the other areas for producing operating strength.

Alternatively, the first adhesive surface can also contain a mixture of silicone cement and another cement, for example, acrylate cement.

Because, in the process in accordance with the invention, for attaching the sealing element, first of all, a first adhesive surface of double-sided adhesive tape, which surface has a silicone cement, is applied to the sealing body, the sealing element is prepared such that, after removing a protective film with its second self-sticking adhesive surface with cement preferably matched to the properties of the corresponding application site, it can be attached easily and quickly to the application site, for example, to one edge of a sliding roof cover or to one such peripheral opening edge.

In the approach in accordance with the invention, it is advantageous that the sealing body of silicone has outstanding properties with respect to temperature resistance, return behavior, tightness and protection against the danger of freezing-on and sticking together and still the sealing element can be attached quickly, easily and with little requirement for installation space to the application site, while, for example, with direct cementing of the sealing body to the application site by means of silicone cement as a result of the resulting long setting time, its use in series production is not possible.

The invention overcomes a prejudice in the field according to which the advantages of a silicone seal cannot be combined with simple mounting using the self-sticking adhesive surface which is provided on the seal. By using an adhesive layer and a crosslinking or completely vulcanizing silicone cement, it is surprisingly possible to produce a positive and non-positive connection between the sealing body and the adhesive tape as well as the application site, which does not have soft-elastic properties and which likewise does not require any additional setting times.

In one preferred embodiment of the invention, the second adhesive surface is formed, for example, by an acrylate cement. Especially preferable is a carrier element of acrylate foam which contains an acrylate cement, and thus, itself, directly forms the second adhesive surface facing the application site. Furthermore, the adhesive surface is preferably made planar.

Between the first and second adhesive surface of the adhesive tape, there is a carrier element which is formed preferably by an acrylate foam. The adhesive surface extends preferably essentially over the entire length of the sealing body. According to one alternative embodiment, the carrier element is formed by a flexible tape.

The sealing element in accordance with the invention, which has a sealing body of silicone, is produced by the sealing body of silicone being continuously produced by the extrusion process in a first process step, and in the second process step, the adhesive tape is at least partially coated with a silicone cement.

In the third process step, the sealing body and the adhesive tape are connected to one another via the silicone cement which forms the first adhesive surface and the adhesive layer, and in a fourth process step, crosslinking of the silicone cement which forms the adhesive surface takes place by the action of temperature and/or pressure and/or moisture.

This process in accordance with the invention makes it possible to control the time of crosslinking or complete vulcanization of the silicone cement which forms the adhesive surface in a monitored manner via the parameters pressure and temperature, so that the sealing element in accordance with the invention, in the attachment to the application site, always has a bonded and non-positive connection between the sealing body and the adhesive tape.

Another process in accordance with the invention for producing the sealing element is characterized by a first process step in which the sealing body of silicone is continuously produced by the extrusion process and in which, in the second process step, at least in part a silicone cement is applied to the planar bottom of the sealing body.

In another process step, the double-sided adhesive tape is connected to the sealing body which has the silicone cement with the interposition of the adhesive layer, and in a fourth process step, crosslinking of the silicone cement which forms the first adhesive surface is implemented by the action of temperature and/or pressure.

When using a carrier element of acrylate foam, between the adhesive surface of silicone cement facing the sealing element and the carrier element, in an intermediate step, the adhesive layer such as, for example, a primer, an enamel, an adhesive, a film, a cloth strip, preferably laminated onto the acrylate foam, or a surface of acrylate foam produced by corona treatment is applied.

Furthermore, it has been advantageously ascertained that the control action of moisture on the silicone cement which forms the first adhesive surface and which is to be crosslinked yields another influencing parameter which benefits the bonded and non-positive connection between the sealing body and the double-sided adhesive tape.

By way of example, two embodiments of the invention is explained in detail below with reference to the accompanying drawings.

### BRIEF DESCRIPTION OF THE DRAWINGS

FIG. 1 is a schematic perspective view of a motor vehicle roof with an openable cover,

FIG. 2 is a cross section through a sealing element which is to be attached to the edge of the cover,

FIG. 3 a cross section taken along line II-II in FIG. 1, through a sealing element which is located on the roof frame, and

FIG. 4 is a cross section through an alternative structure of an adhesive tape with an acrylate foam as the carrier element.

### DETAILED DESCRIPTION OF THE INVENTION

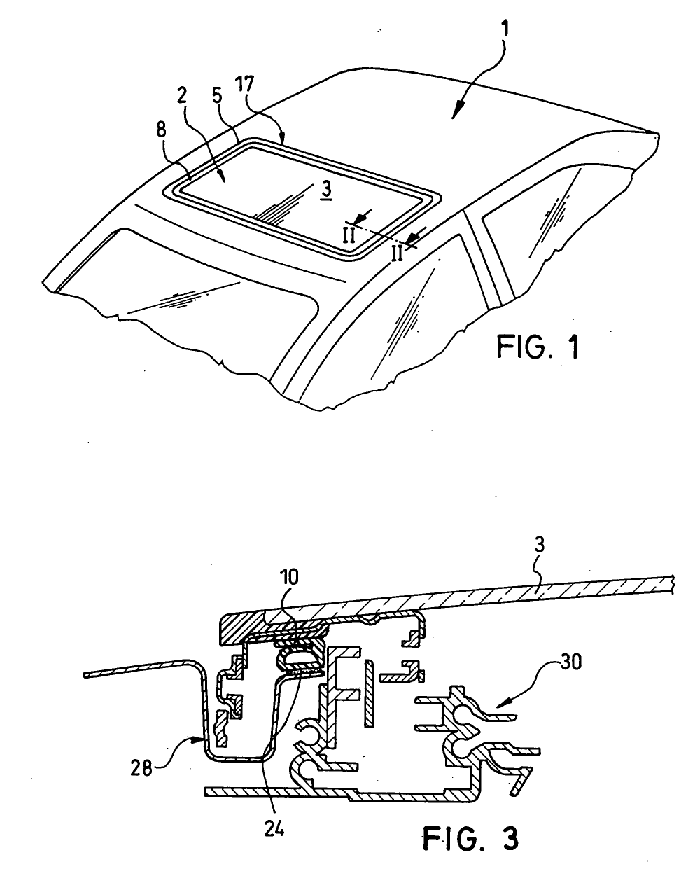

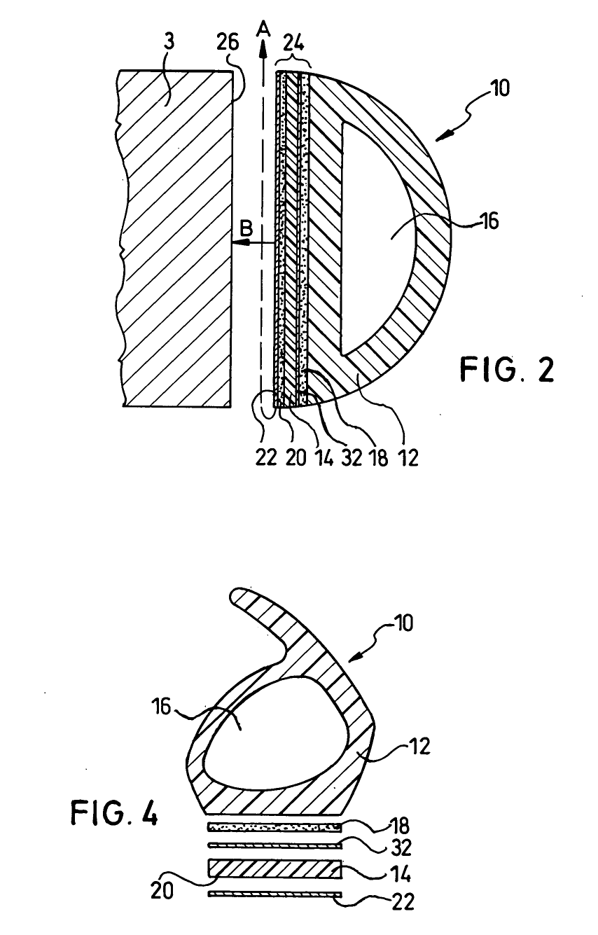

FIG. 1 shows an openable motor vehicle roof 1 in which the roof opening 2 can be selectively closed or at least partially cleared by means of a cover 3. For sealing between an outside edge 26 of the cover 3 (FIG. 2) and the edge 17 of the roof opening 2, there is either a seal 8 on the outer side 26 of the cover 3, as shown in FIG. 2, or a seal 5 on the edge 17 of the roof opening 2.

FIG. 2 shows a sealing element 10 which can be used, for example, as a seal 5 or seal 8, as shown in FIG. 1. The sealing element 10 is formed of a sealing body 12 which is preferably an elongated extrusion profile of silicone with a hollow chamber 16 formed in the extrusion profile. The sealing body 12 is planar on its bottom over the entire length and width thereof.

An adhesive tape 24 has a first adhesive surface 18 that is attached to the sealing element 10; the adhesive surface has a silicone cement which, as a result of the shallow thickness of the layer and the crosslinking, forms a strong connection to the bottom of the sealing body 12.

However, such an adhesive tape 24 is also excellent for use at other application sites at which the positive properties of the silicone are to take direct effect. In particular, seals on or in buildings are also possible in this connection.

The adhesive tape 24 also has a flexible carrier element 14 which adjoins the first adhesive surface 18. The carrier element is preferably made of an acrylate foam and is cemented by bonding and force-fit to the bottom of the sealing body 12 by means of the adhesive surface 18 of silicone cement over the entire length and width. On the side of the carrier element 14 facing away from the sealing body 12, the adhesive tape 24 is provided with a second self-sticking adhesive surface 20 which is used for attachment of the sealing element 10 to the application site.

Before attaching the sealing element 10 to the application site, the adhesive surface 20 is protected by a protective film 22 which is then removed for mounting. The removal of the protective film 22 is indicated by the arrow A and the subsequent joining of the sealing element 10 via the adhesive tape 24 is indicated by the arrow B. The material of the adhesive surface 20 is selected depending on the adhesive base at the application site, an acrylate cement preferably being used especially when using an acrylate foam is used for the carrier element 14. The adhesive surface 20 extends preferably over the entire length and width of the bottom of the adhesive tape 24 and is made essentially planar.

The described sealing element 10 is used preferably for sealing of the cover 3 of an openable motor vehicle roof 1, for example, of a sliding roof, lifting roof, sliding/lifting roof, louvered roof or spoiler roof, and it can also be attached, for example, as a seal 8 to the side edge 26 or also to the bottom of the cover 3 or as a seal 5 to the opening edge 17 of a roof opening 2 which can be closed by the cover 3.

Finally, as is shown in FIG. 3, attachment to the horizontal flange area of a roof frame 28 is also possible. In this case, the cover 3 rests on top of the seal element 10 in the closed state, forming a seal. The guide rail 30 is used to guide the raising and sliding mechanism of the cover 3 (not shown).

In the version shown in FIG. 4, a carrier element 14 of acrylate foam is used which is applied to a protective film 22. The acrylate foam contains an acrylate cement so that the bottom of the carrier element 14 can be attached directly to the adhesive surface 22 at the application site after the protective film 22 is removed. An adhesive layer 32 which is used for adhesion between the carrier element 14 and the adhesive surface 18 of silicone cement is applied to the top of the carrier element 14 which has been formed from the acrylate foam.

The adhesive layer 32 is formed, for example, by a primer, an enamel, an adhesive, a film, a cloth strip preferably laminated onto the acrylate foam or by a surface of acrylate foam produced by corona treatment.

The material E 415 from Wacker Chemie is well suited as the silicone cement for producing the adhesive surface 18. The primer for producing the adhesive layer 32 is, for example, material G 718 from Wacker Chemie. The acrylate foam with an integrated acrylic adhesive surface is an acrylic foam from 3M.

This invention devises a sealing element which has good properties with respect to temperature resistance, return behavior, sealing properties and the danger of freezing-on or sticking together and still can be attached easily and promptly to the application site, in which neither plug-type connections which require a relatively large amount of space and effort for installation, nor liquid silicone cement which entails a long setting time and which leads to a soft-elastic and thus reversible adhesive connection are used.

What is claimed is:

1. Adhesive tape for attachment of a sealing element made of a silicone material to an application site, comprising:
a carrier element,
first and second self-sticking adhesive surfaces, one on each side of the carrier element, the first adhesive surface being for attachment to the sealing element and being formed at least partially of a silicone cement, and the second self-sticking adhesive surface being for attachment to an application site, and
an adhesive layer between the first self-sticking adhesive surface and the carrier element.

2. Adhesive tape in accordance with claim 1, wherein the silicone cement is a crosslinking silicone cement.

3. Adhesive tape in accordance with claim 1, wherein the first self-sticking adhesive surface portions with a cement other than said silicone cement.

4. Adhesive tape in accordance with claim 1, wherein the carrier element is formed of an acrylate foam.

5. Adhesive tape in accordance with claim 4, wherein the acrylate foam of the carrier element forms the second self-sticking adhesive surface.

6. Adhesive tape in accordance with claim 1, wherein the adhesive layer between the first self-sticking adhesive surface and the carrier element is formed of a primer.

7. Adhesive tape in accordance with claim 1, wherein the adhesive layer the adhesive layer between the first self-sticking adhesive surface and the carrier element is formed by a film.

8. Adhesive tape in accordance with claim 1, wherein the adhesive layer between the first self-sticking adhesive surface and the carrier element is formed by an enamel.

9. Adhesive tape in accordance with one of claims 1 to 5, wherein the adhesive layer the between the first self-sticking adhesive surface and the carrier element is formed of another cement.

10. Adhesive tape in accordance with claim 1, wherein the adhesive layer between the first self-sticking adhesive surface and the carrier element is formed by a cloth strip which has been laminated onto the carrier element.

11. Adhesive tape in accordance with one of claims 1 to 5, wherein the adhesive layer between the first self-sticking adhesive surface and the carrier element is formed by the surface of the carrier element which has been subjected to a corona treatment.

12. A sealing element for use in motor vehicles, comprising
a sealing body made of silicone,
a carrier element,
first and second self-sticking adhesive surfaces, one on each side of the carrier element, the first adhesive surface being attached to the sealing element and being formed at least partially of a silicone cement, and
a protective film attached over the second self-sticking adhesive surface, said protective film being removable for attachment of the sealing element to an application site by said second self-sticking adhesive surface.

13. Sealing element in accordance with claim 12, wherein the second adhesive surface is formed of an acrylate cement.

14. Sealing element in accordance with claim 13, wherein the carrier element is an acrylate foam.

15. Sealing element in accordance with claim 12, wherein the carrier element is a flexible tape.

16. Sealing element in accordance with claim 12, wherein the silicone cement has been crosslinked with the sealing body and the carrier element.

17. Sealing element in accordance with claim 12, wherein the first adhesive surface extend essentially over the entire length of the sealing body.

18. Process in accordance with claim 14, wherein the second adhesive surface is formed directly by the acrylate foam of the carrier element.

19. Process for producing a sealing element for use in motor vehicles, which comprises a sealing body made of silicone, comprising the steps of:
a) extruding the sealing body,
b) applying a silicone cement, which forms a first adhesive surface, to an adhesive layer of a carrier element of an adhesive tape,
c) connecting the sealing body to the first adhesive surface,
d) crosslinking the silicone cement of the first adhesive surface by action at least one of temperature and pressure.

20. Process for producing a sealing element for use in motor vehicles, which comprises a sealing body made of silicone, comprising the steps of:
a) extruding the sealing body,
b) producing a carrier element from acrylate foam with a protective film on one side of the carrier element,
c) applying an adhesive layer to a second side of the carrier element,
d) applying silicone cement to the adhesive layer, forming an adhesive surface,
e) connecting the sealing body to the adhesive surface,
f) crosslinking of the silicone cement by the action of at least one of temperature, pressure and moisture.

21. Process in accordance with claim 20, wherein the adhesive layer is formed by a primer on the carrier element.

22. Process in accordance with claim 20, wherein the adhesive layer is formed by an enamel which has been applied to the carrier element.

23. Process in accordance with claim 20, wherein the adhesive layer is formed by a cement which has been applied to the carrier element.

24. Process in accordance with claim 20, wherein the adhesive layer is formed by a film which has been applied to the carrier element.

25. Process in accordance with claim 20, wherein the adhesive layer is formed by applying a cloth strip to the carrier element.

26. Process in accordance with claim 20, wherein the adhesive layer is formed by treating a surface of the carrier element by means of a corona treatment.
